(19) United States
(12) Patent Application Publication
(10) Pub. No.: US 2009/0025664 A1
(43) Pub. Date: Jan. 29, 2009

(54) INTERNAL COMBUSTION ENGINE

(76) Inventor: Hiroki Nagafuchi, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/162,615

(22) PCT Filed: Jan. 31, 2007
(86) PCT No.: PCT/IB2007/000785

§ 371 Date: Jul. 30, 2008

(30) Foreign Application Priority Data
Jan. 31, 2006 (JP) 2006-021925

(51) Int. Cl. F02B 75/20

(52) U.S. Cl. 123/58.1

(57) ABSTRACT

Exhaust ports (8 and 9) of paired middle cylinders (#2 and #3) in which respective power strokes take place with one intervening power stroke therebetween are joined together in a cylinder head (1) to form a joint exhaust port (11). Exhaust ports (7 and 10) of paired end cylinders (#1 and #4) in which respective power strokes take place with one intervening power stroke therebetween extend from the respective cylinders (#1 and #4) toward the joint exhaust port (11). Then, on the respective sides of the joint exhaust port (11), the exhaust ports (7 and 10) extend along the joint exhaust port (11) to a side wall face (5) of the cylinder head (1) while the exhaust ports (7 and 10) and the joint exhaust port (11) are separated from each other by respective thin walls (12 and 13).

### BACKGROUND OF THE INVENTION

1. Field of the Invention

The invention relates to an internal combustion engine.

2. Description of the Related Art

For example, Japanese Patent Application Publication No. 2003-176722 (JP-A-2003-176722) describes an inline four-cylinder internal combustion engine. In the described internal combustion engine, an exhaust manifold, which extends from a cylinder disposed on one end to a cylinder disposed on the other end, is fitted on the side wall face of the cylinder head, exhaust ports of these cylinders disposed on the opposite ends open into the exhaust manifold, and exhaust ports of two cylinders disposed at the middle are joined together so as to open into the exhaust manifold.

However, the exhaust manifold causes the inconvenience, such as large size, causing the exhaust manifold to occupy a lot of space in an engine room. In order to minimize the inconvenience, the exhaust ports of all the cylinders are joined together within the cylinder head so as to form an exhaust port joint portion that opens on the side wall face of the cylinder head, and an exhaust pipe is connected to the opening of the exhaust port joint portion.

However, if the exhaust ports of all the cylinders are joined together within the cylinder head, pressure pulsation in each cylinder affects a discharge of exhaust gas from the other cylinders, namely, exhaust gas discharged from the different cylinders interfere with each other. In addition, the opening of the exhaust port joint portion is overheated due to the exhaust gas discharged to all the exhaust ports flowing through the opening of the exhaust port joint portion entirely.

### SUMMARY OF THE INVENTION

An aspect of the invention relates to an inline four-cylinder internal combustion engine that includes a cylinder head which has exhaust ports formed therein and a side wall face on which the exhaust ports open. In the internal combustion engine, the exhaust ports of paired middle cylinders which are disposed at the middle of the inline four-cylinder and in which respective power strokes take place with one intervening power stroke therebetween are joined together within the cylinder head so as to form a joint exhaust port, and the joint exhaust port extends to the side wall face of the cylinder head. Also, the exhaust ports of paired end cylinders which are disposed on opposite ends of the inline four-cylinder and in which respective power strokes take place with one intervening power stroke therebetween extend from the respective cylinders toward the joint exhaust port. Then, on the respective sides of the joint exhaust port, the exhaust ports extend along the joint exhaust port to the side wall face of the cylinder head while the exhaust ports and the joint exhaust port are separated from each other by respective thin walls.

The invention makes it possible to form the openings of the exhaust ports at positions close to each other, while preventing contact of exhaust gas discharged from different cylinders and overheating of the openings of the exhaust ports.

### BRIEF DESCRIPTION OF THE DRAWINGS

The forgoing and further objects, features and advantages of the invention will become apparent from the following description of example embodiments with reference to the accompanying drawings, wherein the same or corresponding portions will be denoted by the same reference numbers and wherein:

FIG. 1 is a plane cross-sectional view of a cylinder head;

FIG. 2 is a cross-sectional view taken along the line II-II in FIG. 1;

FIG. 3 is a perspective view showing the shapes of exhaust ports;

FIG. 4 is an elevation view of a side wall face of the cylinder head; and

FIG. 5 is a perspective view of part of an internal combustion engine.

### DETAILED DESCRIPTION OF THE EMBODIMENT

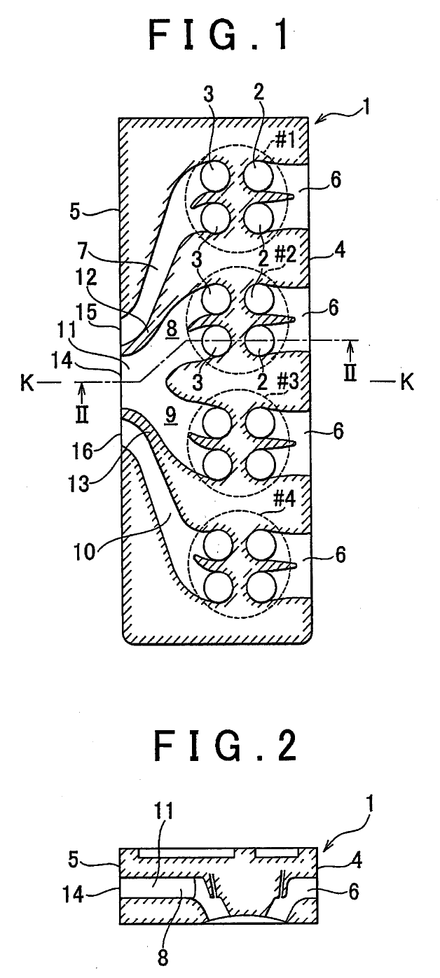

FIGS. 1 and 2 show a single-piece cylinder head 1 that is cast in an aluminum alloy. The circles indicated by the dashed lines in FIG. 1 show the arrangement of a first cylinder #1, a second cylinder #2, a third cylinder #3, and a fourth cylinder #4. Accordingly, an internal combustion engine shown in FIG. 1 is an inline four-cylinder internal combustion engine and includes the cylinder head 1. In FIG. 1, reference numerals 2 each denote a valve port that is opened/closed by an intake valve, and reference numerals 3 each denote a valve port that is opened/closed by an exhaust valve. Thus, each of the cylinders #1, #2, #3 and #4 is provided with a pair of intake valves and a pair of exhaust valves.

The cylinder head 1 actually has a coolant passage that extends along a complex path, a portion at which a valve mechanism is supported, a portion in which a spark plug is inserted, a portion in which a fuel injection valve is inserted, etc. formed therein. However, these passage and portions are omitted from FIGS. 1 and 2.

The cylinder head 1 has side wall faces 4 and 5 that are formed on the opposite sides of the plane including the axes of the cylinders #1, #2, #3 and #4. The side wall faces 4 and 5 extend substantially parallel to this plane. Intake ports 6 of the cylinders #1, #2, #3 and #4 formed within the cylinder head 1 open on the side wall face 4.

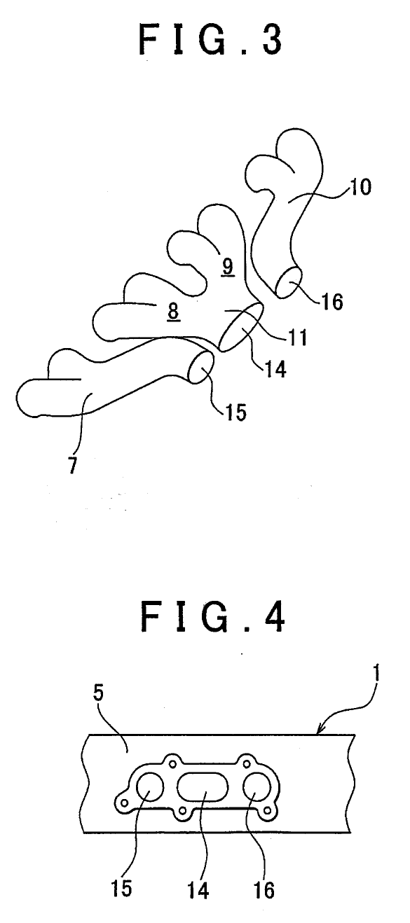

Formed within the cylinder head 1 are: an exhaust port 7 of the first cylinder #1, an exhaust port 8 of the second cylinder #2, an exhaust port 9 of the third cylinder #3, and an exhaust port 10 of the fourth cylinder #4. FIG. 3 shows the perspective view of the shapes of these exhaust ports 7, 8, 9 and 10. As shown in FIG. 1, each of the exhaust ports 7, 8, 9 and 10 branches off into two portions, at a portion near the corresponding pair of the valve ports 3, while each of the exhaust ports 7, 8, 9 and 10 is formed in a single exhaust port, at a portion slightly apart from these valve ports 3.

As shown in FIG. 1, the exhaust ports of the paired middle cylinders, namely, the exhaust port 8 of the second cylinder #2 and the exhaust port 9 of the third cylinder #3 are joined together within the cylinder head 1 so as to form a joint exhaust port 11, and the joint exhaust port 11 extends to the side wall face 5 of the cylinder head 1. Hereafter, the plane that extends through the center portion between the second cylinder #2 and the third cylinder #3 in the axial direction of the cylinders and that is perpendicular to the plane including the axes of the cylinders #1, #2, #3 and #4 will be referred to as the symmetry plane K-K. The exhaust port 8 of the second cylinder #2 and the exhaust port 9 of the third cylinder #3 are arranged symmetrically with respect to the symmetry plain K-K. The joint exhaust port 11 extends along the symmetry plane K-K to the side wall face 5 of the cylinder head 1.

The exhaust ports of the paired end cylinders, namely, the exhaust port 7 of the first cylinder #1 and the exhaust port 10 of the fourth cylinder #4 are also arranged symmetrically with respect to the symmetry face K-K. The exhaust port 7 of the first cylinder #1 extends from the first cylinder #1 toward the joint exhaust port 11. Then, on one side of the joint exhaust port 11, the exhaust port 7 extends along the joint exhaust port 11 to the side wall face 5 of the cylinder head 1 while the exhaust port 7 and the joint exhaust port 11 are separated from each other by a thin wall 12. Similarly, the exhaust port 10 of the fourth cylinder #4 extends from the fourth cylinder #4 toward the joint exhaust port 11. Then, on the other side of the joint exhaust port 11, the exhaust port 10 extends along the joint exhaust port 11 to the side wall face 5 of the cylinder head 1 while the exhaust port 10 and the joint exhaust port 11 are separated from each other by a thin wall 13.

As shown in FIG. 1, the lengths of the thin walls 12 and 13 that extend along the exhaust ports 7 and 10 are greater than the diameters of the exhaust ports 7 and 10, respectively. Also, the thickness of the thin wall 12 is smaller than the distance between the valve port 3 which is closer to the second valve #2 of the two valve ports 3 connected to the first cylinder #1, and the valve port 3 which is closer to the first cylinder #1 of the two valve ports 3 connected to the second cylinder #2. Similarly, the thickness of the thin wall 13 is smaller than the distance between the valve port 3 which is closer to the fourth cylinder #4 of the two valve ports 3 connected to the third cylinder #3, and the valve port 3 which is closer to the third cylinder #3 of the two valve ports 3 connected to the fourth cylinder #4. As shown in FIGS. 1 to 4, the exhaust port 7 of the first cylinder #1 and the exhaust port 10 of the fourth cylinder #4 open on the side wall face 5 of the cylinder head 1 at an opening 15 of the exhaust port 7 and an opening 16 of the exhaust port 10 on the respective sides of an opening 14 at which the joint exhaust port 11 opens.

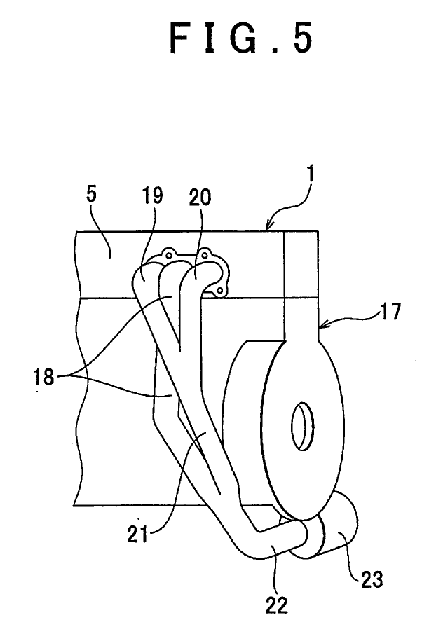

FIG. 5 shows part of the internal combustion engine. In FIG. 5, the reference numeral 17 denotes a cylinder block. As shown in FIG. 5, on the side wall face 5 of the cylinder head 1, an exhaust pipe 18 for joint exhaust port 11 (hereinafter, referred to as a joint exhaust port exhaust pipe 18″) is connected to the opening 14 of the joint exhaust port 11. On the side wall face 5 of the cylinder head 1, branch pipes 19 and 20 are connected to the opening 15 of the exhaust port 7 and the opening 16 of the exhaust port 10, respectively. These exhaust branch pipes 19 and 20 are joined together so as to form an exhaust branch joint pipe 21. The exhaust branch joint pipe 21 is connected to the joint exhaust port exhaust pipe 18 so as to form a joint exhaust pipe 22. Below the cylinder block 17, the joint exhaust pipe 22 passes across the cylinder block 17, and is connected to a catalytic converter 23.

As shown in FIG. 5, the exhaust branch pipes 19 and 20 are arranged near the joint exhaust port exhaust pipe 18 and extend along the joint exhaust port exhaust pipe 18. The exhaust branch joint pipe 21 is also arranged near the joint exhaust port exhaust pipe 18 and extend along the joint exhaust port exhaust pipe 18. Accordingly, an exhaust system formed of these exhaust pipes occupies only a small fraction of the space.

In the embodiment of the invention, the firing order of the cylinders in the internal combustion engine is #1→#3→#4 →#2 or #1→#2→#4→#3. In either of these orders, a pair of the cylinders in which the respective power strokes take place with one intervening power stroke therebetween is a pair of the middle cylinders, namely, the second cylinder #2 and the third cylinder #3 (an intervening power stroke takes place between the power strokes of the second cylinder #2 and the third cylinder #3). Another pair of such cylinders is a pair of the end cylinders, namely, the first cylinder #1 and the fourth cylinder #4 (an intervening power stroke takes place between the power strokes of the first cylinder #1 and the fourth cylinder #4). In this case, if all the exhaust ports are joined together within the cylinder head 1, positive pressure produced in the exhaust port of one cylinder during the exhaust stroke is applied to the exhaust port of another cylinder, where the power stroke subsequently takes place, during the exhaust stroke. This hampers a smooth discharge of the burned gas from a combustion chamber.

In contrast, according to the embodiment of the invention, the exhaust ports of only the cylinders, in which the respective power strokes take place with one intervening power stroke therebetween, are joined together, namely, the exhaust port 8 of the second cylinder #2 and the exhaust port 9 of the third cylinder #3 are joined together, and the exhaust port 7 of the first cylinder #1 and the exhaust port 10 of the fourth cylinder #4 are joined together. With this structure, while exhaust gas is discharged through the exhaust port of one cylinder during the exhaust stroke, positive pressure produced in the exhaust port of another cylinder is not applied to the exhaust port of the one cylinder. As a result, the burned gas is smoothly discharged from the combustion chamber. Namely, interference of the exhaust gas discharged from the different exhaust ports is prevented, which makes it possible to discharge the exhaust gas with high degree of efficiency.

The exhaust gas flows through the opening 14 of the joint exhaust port 11 during only the exhaust stroke of every other cylinder, instead of during the exhaust strokes of all the cylinders. This prevents overheating around the opening 14. In addition, the exhaust gas flows through the opening 15 of the first cylinder #1 and the opening 16 of the fourth cylinder #4 only once in one cycle of the corresponding cylinders #1 and #4. Because of this configuration, there is a little chance of overheating around the openings 15 and 16.

The distance from the valve port 3 to the opening 15 and the distance from the valve port 3 to the opening 16, that is, the passage lengths of the exhaust ports 7 and 10 are longer than the passage lengths of the exhaust ports 8 and 9, respectively. Accordingly, the temperature of the exhaust gas flowing through the exhaust ports 7 and 10 decreases by a larger amount than the temperature of the exhaust gas flowing through the exhaust port 11. Therefore, the thin wall 12 formed between the joint exhaust port 11 and the exhaust port 7 and the thin wall 13 formed between the joint exhaust port 11 and the exhaust port 10 are cooled by the exhaust gas flowing through the exhaust port 7 and the exhaust port 10, respectively. This prevents overheating around the opening 14 of the joint exhaust port 11 further reliably.

1. An inline four-cylinder internal combustion engine comprising:
a cylinder head which has exhaust ports formed therein, and
a side wall face on which the exhaust ports open, wherein
the exhaust ports of paired middle cylinders which are disposed at the middle of the inline four-cylinder and in which respective power strokes take place with one intervening power stroke between the respective power strokes are joined together within the cylinder head so as to form one joint exhaust port, and the joint exhaust port extends to the side wall face of the cylinder head,
the exhaust ports of paired end cylinders which are disposed on opposite ends of the inline four-cylinder and in which respective power strokes take place with one intervening power stroke between the respective power strokes extend from the respective cylinders toward the joint exhaust port, and then, on respective sides of the joint exhaust port, extend along the joint exhaust port to the side wall face of the cylinder head while the exhaust ports and the joint exhaust port are separated from each other by respective thin walls, and
the middle cylinders are connected to the respective exhaust ports via first valve ports, the end cylinders are connected to the respective exhaust ports via second valve ports, and a thickness of each thin wall is smaller than a distance between the first valve port and the second valve port that are disposed adjacent to each other.

2. The internal combustion engine according to claim 1, wherein
a passage length of each of the exhaust ports of the paired end cylinders is longer than a passage length of each of the exhaust ports of the paired middle cylinders.

3. The internal combustion engine according to claim 1, wherein
the exhaust ports of the paired end cylinders open on the side wall face of the cylinder head, at positions on respective sides of an opening of the joint exhaust port.

4. The internal combustion engine according to claim 1, wherein
a joint exhaust port exhaust pipe is connected to the opening of the joint exhaust port, at a position on the side wall face of the cylinder head,
exhaust branch pipes are connected to openings of the exhaust ports of the paired end cylinders, at positions on the side wall face of the cylinder head, and
the exhaust branch pipes are joined together and then connected to the joint exhaust port exhaust pipe.

5. The internal combustion engine according to claim 4, wherein
the exhaust branch pipes are arranged near the joint exhaust port exhaust pipe and extend along the joint exhaust port exhaust pipe.

6. The internal combustion engine according to claim 4, wherein
the exhaust branch pipes are joined together so as to form an exhaust branch joint pipe, and the exhaust branch joint pipe is arranged near the joint exhaust port exhaust pipe and extend along the joint exhaust port exhaust pipe.

7. The internal combustion engine according to claim 1, wherein,
when the paired middle cylinders are a second cylinder and a third cylinder, and the paired end cylinders are a first cylinder and a fourth cylinder, the respective power strokes take place in order of the first cylinder, the third cylinder, the fourth cylinder, and the second cylinder; or the first cylinder, the second cylinder, the fourth cylinder, and the third cylinder.

8. The internal combustion engine according to claim 1, wherein
a length of the thin wall is greater than a diameter of the exhaust port.

9. (canceled)
